(19) United States
(12) Patent Application Publication
(10) Pub. No.: US 2016/0348399 A1
(43) Pub. Date: Dec. 1, 2016

(54) ELECTROSTATIC LOCK

(71) Applicant: Evgeniy Anatolevich OBZHIROV, Moscow (RU)

(72) Inventor: Evgeniy Anatolevich OBZHIROV, Moscow (RU)

(21) Appl. No.: 15/113,073

(22) PCT Filed: Apr. 2, 2014
(86) PCT No.: PCT/RU2014/000239

§ 371 Date: Jul. 21, 2016

(30) Foreign Application Priority Data
Jan. 22, 2014 (RU) 2014101699

(51) Int. Cl. E05B 47/00; H02N 13/00

(52) U.S. Cl. CPC E05B 47/00; H02N 13/00; E05B 2047/0057

(57) ABSTRACT

An electrostatic lock (ESL) relates to devices for fixing and holding in a fixed state, relative to one another, individual parts or elements of various mechanisms and devices. An ESL provides the possibility of subsequent disengagement and functions by means of the electrostatic (Coulomb) force of attraction between electrodes charged with opposite electrical charges and separated by a thin layer of a dielectric material. The ESL guarantees fixing of the elements upon closing. The ESL includes a rectifier in the ESL power-supply circuit which blocks the reverse current of a discharge through a power-supply element, and stabilizes the process of accumulating electrical charges of the opposite sign on another electrode by means of the effect of electrostatic induction caused by the charges on the first electrode, which is charged with the help of the rectifier, and all of which, together, guarantees closing of the ESL.

### FIELD OF THE INVENTION

An electrostatic lock (ESL) relates to devices for releasably fixing and holding in a fixed state, relative to one another, individual parts or elements of various mechanisms and devices and functions by means of the electrostatic (Coulomb) force of attraction between electrodes which are charged with opposite electrical charges and separated by a thin layer of dielectric material.

### INDUSTRIAL APPLICABILITY

The device may serve as a locking device or a lock, as well as a variety of other similar engineering purposes. The device is controlled (opened and closed) by applying a voltage of the required magnitude to its electrodes what beneficially distinguishes the device of the invention from the electromagnetic lock, controlled by turning the electromagnet circuit current on and off

### DESCRIPTION OF THE RELATED ART

The most similar locking device to the electrostatic lock is an electrostatic lock disclosed in RF Utility Model Patent No. 129134 which is a device for fixing and holding in a fixed state, relative to one another, individual parts or elements of mechanical devices by means of an electrostatic (Coulomb) force of attraction. This devise comprises of fixable electrodes which are coupled, mechanically or kinematically with the individual parts or elements fixable, relative to one another. The electrodes are charged when connected to an electric power supply with electrical charges of opposite polarities. The device further comprises of at least one layer of a dielectric which separates the electrodes chargeable with electrical charges of opposite polarities from each other so that, upon fixing (closing) of the ESL, the oppositely charged electrodes are located closely adjacent to each other and are separated by the dielectric. The device also comprises of at least two rectifiers, connecting the ESL electrodes to the electric power supply. The rectifiers are connected directly to their respective electrode or group of electrodes, ensuring they are charged with an electric charge of a certain polarity (opposite to that of the other electrode or group of electrodes), eliminating completely or minimalizing most of the current in the reverse direction of the electrode charging current.

The principal distinctive feature of the above device is the existence of at least two rectifiers within one of the two electrode groups. The rectifiers accumulate charges of the same polarity and ensure, when closing the ESL, a stable generation of charges at these electrodes. A simple connection of the electrodes to an electric current supply, such as a storage battery or a DC galvanic cell, using no rectifier, proves to be insufficient, as in such a closed electric system, with a mechanical degree of freedom for the movement of electrodes relative to one another (in fact, the electrodes form a variable capacitor whose capacity depends on a gap between the electrodes: the more the gap, the lower the electrical capacity), the closed condition is a condition with the maximum of electrostatic energy and is an unstable equilibrium point: with a constant voltage being applied to the electrodes, the electrostatic energy is directly proportional to the electrical capacity of the electrode system which capacity is reduced quickly as the gap is increased. The employment of the rectifiers makes it possible to rectify the situation: one of the rectifiers locks positive charges at the respective electrode or group of electrodes as it has a unilateral conductivity while the other rectifier locks negative charges at the other electrode or group of electrodes preventing them from being discharged reversely. In such a device, a charge magnitude which has been accumulated at the electrodes by the moment of closing of the ESL becomes a constant, while a capacitor's energy becomes inversely proportional to its capacity, and a closed condition with a zero gap becomes the minimum energy level. This ensures the stability of the Coulomb forces of attraction between the electrodes upon closing of the ESL and remaining in the closed condition afterward.

It was found, however, that taking into consideration the effect of electrostatic induction, which was not taken into consideration in the above prior art, makes it possible to provide the ESL with one rectifier proper connection of which to the charging unit of the ESL, and simultaneously proper connection of electrodes also result in successfully achieving the above-described technical result of charge stabilization of electrodes of upon closing thereof

### DESCRIPTION OF THE INVENTION

The electrostatic induction effect describes an electrostatic field of external electric charges brought near a conductor causing a redistribution of electric charges in the conductor so that an electric field produced by the external electric charges inside the conductor is equal to zero. If a charge of a certain polarity is brought near the conductor, a charge of the opposite polarity (induced charge 1) will be collected on the surface of the conductor facing the external charge, while a charge (induced charge 2) equivalent thereto in magnitude, whose polarity is opposite to that of induced charge 1, and is the same as that of the external charge, will be redistributed along the surface of the conductor till the complete potential equalization on the surface of that conductor.

Referring now to FIG. 1, the ESL comprises two flat electrodes 1 and 8 and a dielectric 2, separating the flat electrodes from each other; the flat electrodes are movable, relative to one another, in the direction perpendicular to the plane of the flat electrodes, resulting in an air gap forming within the space between the flat electrodes. The electrode 1 is connected to a power (charge) supply 4 with the help of an electric switch 5, through rectifier 6 while the electrode 8 is directly connected to the other pole of the same power supply. During closing of the ESL, the accumulation of charges at the electrode 1 is stabilized by the rectifier which blocks a reverse discharge current. If there is no rectifier, such current would occur whenever voltage between the ESL electrodes is more than the emf of the power supply, which occurs every time upon the formation of any air gap between the ESL electrodes, once the ESL have been charged completely. Due to the electrostatic induction as described above, a charge which has been accumulated at the electrode 1 induces a charge at the electrode 8 equivalent thereto in magnitude and opposite in polarity (induced charge 1), while the respective induced charge 2 is neutralized at the power supply. Since during and after closing of the ESL, any reduction in the charge at the electrode 1 is blocked by the rectifier, the magnitude of induced charge 1 at the electrode 8 due to the electrostatic induction also may not be reduced and both charges are in a stable state this resulting in a normal operation of the ESL in a closed condition.

### THE BEST EMBODIMENT OF THE INVENTION

Thus, one rectifier is sufficient to lock and stabilize charges at the ESL electrodes, which valve will retain the charges at one of the electrodes or at the respective group of electrodes chargeable with electric charges of the same polarity. The accumulation of charges of the opposite polarity at the other electrode or group of electrodes will be stabilized by the electrostatic induction effect. The device depicted in FIG. 1 will operate successfully in most cases, for example, if a given group of electrodes is not exposed to a strong external electromagnetic field.

A plurality of technical results is achieved by the present invention, namely: the main result being the stabilization of ESL electrode charges and the creation of conditions reducing to zero the reverse flow of charges from the electrodes and ensuring a normal closing of the ESL; the simplification of configuration with the possibility of the disposition of the rectifier in the most convenient and protected portion of the ESL; and an improvement in compactness, cost effectiveness, and reliability of the device of the invention on account of quantity reduction of parts and components.

On the basis of all of the foregoing it may be concluded that the features which determine the invention claimed and described above under Description of the invention reflect to the fullest extent the essence of the invention (the ESL) and the device as depicted in FIG. 1 is the best embodiment of the ESL.

### FURTHER EMBODIMENTS

The present invention allows also using further possibilities to improve the ESL. FIG. 2 shows the ESL characterized in that it comprises an additional electrode 10, isolated from the electrical charging circuit for the electrodes 1 and 8. Charges at the electrodes 1 and 8 are produced in a similar way by power (charge) supply 4, while charges at the electrode 10 are produced due to an additional electrostatic induction caused by the charges at the electrodes 1 and 8. In such a case, the fixing of the ESL in the closed condition occurs due to electrostatic forces of attraction which occur between the charge at the electrode 1 and the induced charge at the electrode 10 and the charge at the electrode 8, and the other induced charge at the electrode 10. Such a design makes it possible to dispose the electrodes 1 and 8 as close to each other (and to the power supply) as possible, at a fixed distance which in contrast to the device of FIG. 1, may be constant in any condition of the ESL—in the open condition or closed condition.

Further embodiments of the ESL are also possible. In the ESL of FIG. 1, an electrical contact between the electrode 1 and the electrode 8 is established at the moment of charging (closing of the ESL), and charges go from one electrode to the other under the action of the emf of the power supply 4. The employment of the electrostatic induction effect makes it possible to implement those embodiments of the ESL which do not need such an electric contact. FIGS. 3 and 4 depict the ESL wherein, upon closing of the ESL, the electrode 1 is charged from the power supply one of the poles of which is connected to the electrode 1 through the rectifier 6, and the other pole is connected to a grounding device 9. The charge at the electrode 8, interacting with the charge at the electrode 1, appears under the action of the electrostatic induction effect. Since operational currents and charges of the ESL are small, the provision of the ESL with a grounding device, which is sufficient for its operation and safe for users, may be significantly simpler and cheaper than the provision of an electrical connection of the electrodes 1 and 8. The ESL in FIG. 4 differs from the ESL in FIG. 3 in that the electrode 8 is also connected to the grounding device 9 to prevent a parasitic induced charge 2, from being accumulated at the periphery of the electrode 8. Such a configuration improves the reliability of the ESL and makes the operation thereof fully safe.

### BRIEF DESCRIPTION OF THE DRAWINGS

In order to make the above description clearer, reference is made to the accompanying drawings, in which:

FIG. 1 illustrates an electrostatic lock (ESL) which comprises electrodes 1 and 8; dielectrics 2 which separate the electrodes from each other; a gap 3 between the dielectrics which may be reduced to zero; a power supply 4; an electric switch 5; one rectifier 6 connected into a charging circuit of the electrode 1 to stabilize the charge at this electrode; the charge stabilization at the opposite electrode 8 is ensured by electrostatic induction; the electrostatic lock further comprises a shunting resistor 7 required to neutralize an electrode discharge current occurring upon opening of the ESL;

FIG. 2 illustrates an electrostatic lock (ESL) which differs from the ESL of FIG. 1 in that it comprises, apart from the primary electrodes 1 and 8 chargeable directly from an electric power supply, a secondary electrode 10, at which charges are induced by charges at the primary electrodes;

FIG. 3 illustrates an electrostatic lock (ESL) which differs from the ESL of FIG. 1 in that, upon closing of the ESL, one of the poles of the power supply 4 is connected to the electrode 1 through a rectifier 6, while the other pole is connected to the grounding device 9 the electrode 8 being completely isolated from both power supply and other components of the ESL; and

FIG. 4 illustrates an electrostatic lock (ESL) which differs from the ESL of FIG. 3 in that the secondary electrode 8 is connected to the grounding device 9.

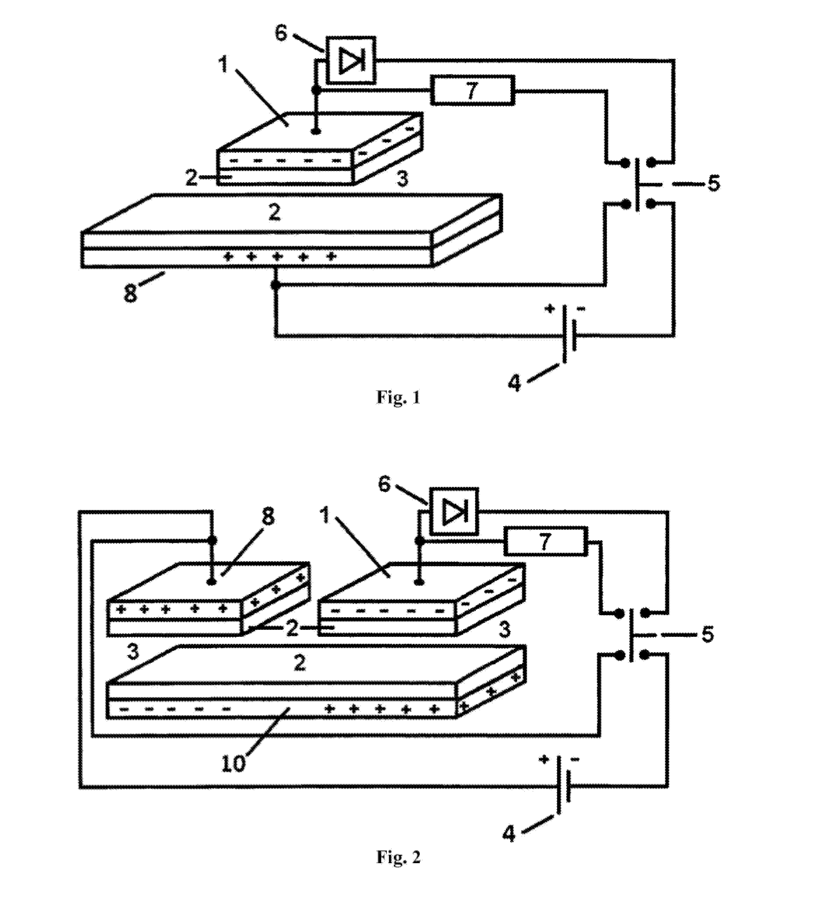

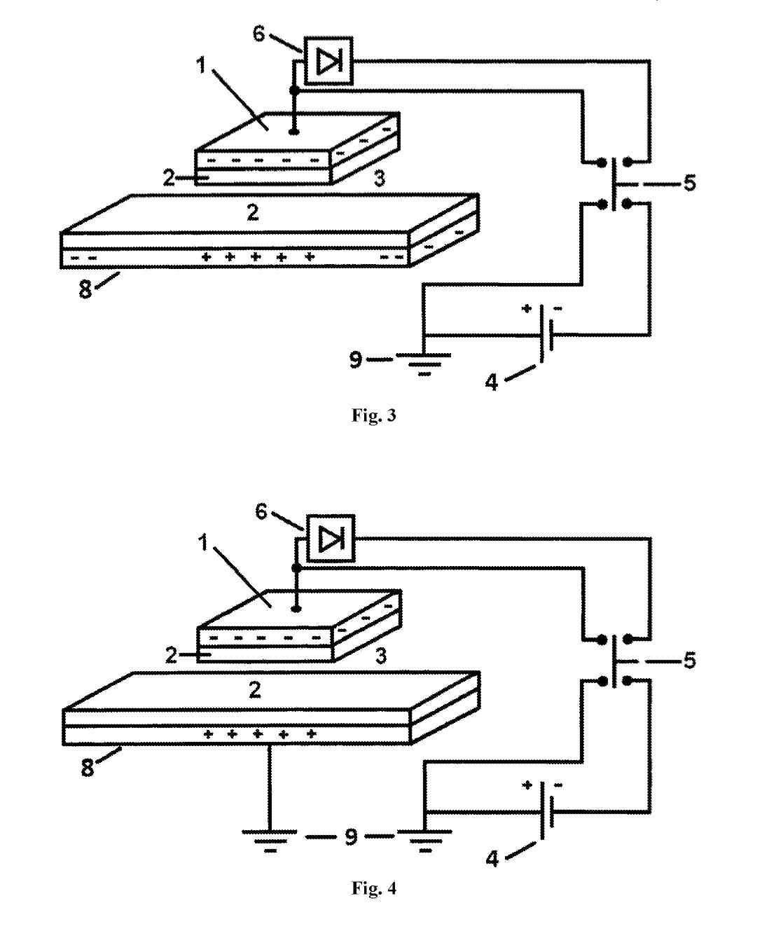

What is claimed is:

1. An electrostatic lock (ESL) being a device for fixing and holding in a fixed state, relative to one another, individual parts or elements of mechanical devices by means of the electrostatic (Coulomb) force of attraction,
the device comprising fixable electrodes which are coupled mechanically or kinematically with the individual parts or elements fixable relative to one another, the electrodes are capable of being connected to an electric power supply to charge the electrodes with electrical charges of opposite polarities, the device further comprising at least one layer of a dielectric, separating the electrodes chargeable with electrical charges of opposite polarities from each other so that upon fixing (closing) of the ESL, the oppositely charged electrodes are located closely adjacent to each other being separated by the dielectric,
wherein to connect one of the electrodes or group of electrodes chargeable with the same electric charge (a principal group of electrodes) to the electric power supply upon closing of the ESL, said device comprises a rectifier connected directly to the principal group of electrodes to ensure charging them with an electric charge of a certain polarity and to eliminate completely, or minimize as much as possible, a current in the reverse direction to that of the charging current, another electrode or electrodes (a non-principal group of electrodes) being located, upon closing of the ESL, closely adjacent to the electrodes of the principal group being separated by the dielectric from each other and being in electrical contact with the opposite pole of the electric power supply from which they are charged with an electric charge of the opposite polarity.

2. The electrostatic lock (ESL) of claim 1, wherein the non-principal group of electrodes is isolated from the electric power supply, and upon closing of the ESL, an electric charge, at said electrodes, is caused by the electrostatic induction on the surface of contact, through the layer of the dielectric, with the electrodes of the principal group chargeable from the power supply through the rectifier, the electrostatic lock further comprises a grounding device which, at the moment of closing of the ESL, is in electrical contact with the pole of the electric power supply opposite to the pole from which the principal group of electrodes is charged.

3. The electrostatic lock (ESL) of claim 2, wherein the non-principal group of electrodes is in a constant electrical contact with the grounding device.

4. The electrostatic lock (ESL) of claim 1, wherein, apart from the electrodes chargeable directly from the electric power supply (the primary electrodes which comprise both the principal group and the non-principal group), the electrostatic lock comprises one or more short-circuited to each other or grounded electrodes (the secondary electrodes) separated from each other by one or more layers of dielectric and located closely adjacent to each other upon fixing (closing) of the ESL, thus, upon accumulation of electrical charges at the primary electrodes, secondary charges, induced by electric fields of the charges at the primary electrodes, are accumulated at the secondary electrodes on the surface of contact through the dielectric, with the primary electrodes on account of electrostatic induction, the induced secondary charges having the opposite polarity, with respect to the primary charges inducing them, thus producing an electrostatic attraction force between primary and secondary electrodes.
